(19) United States
(12) Patent Application Publication
(10) Pub. No.: US 2018/0193951 A1
(43) Pub. Date: Jul. 12, 2018

(54) LASER WELDING METHOD, HIGH PRESSURE FUEL SUPPLY PUMP, AND FUEL INJECTION VALVE

(71) Applicant: Hitachi Automotive Systems, Ltd., Hitachinaka-shi, Ibaraki (JP)

(72) Inventors: Masanori MIYAGI, Tokyo (JP); Masayuki ICHINOHE, Hitachinaka-shi (JP); Xudong ZHANG, Tokyo (JP); Tatsuro KUROKI, Hitachinaka-shi (JP)

(73) Assignee: Hitachi Automotive Systems, Ltd., Hitachinaka-shi, Ibaraki (JP)

(21) Appl. No.: 15/742,118

(22) PCT Filed: Jun. 10, 2016
(86) PCT No.: PCT/JP2016/067372

§ 371 Date: Jan. 5, 2018

(30) Foreign Application Priority Data
Jul. 8, 2015 (JP) 2015-136614

(51) Int. Cl. B23K 26/082; B23K 26/06; B23K 26/046; B23K 26/242

(52) U.S. Cl. CPC B23K 26/082; B23K 26/06; B23K 26/244; B23K 26/242; B23K 26/046

(57) ABSTRACT

It is an object of the present invention to provide a laser welding method making it possible to secure the effective welding length when the laser beam is applied obliquely. In a laser welding method in which oscillation scanning is periodically effected with a laser beam 4 while moving an object of welding 9 to apply the laser beam to a surface of the object of welding 9 to perform welding, at least one of the output of the laser beam 4, a scanning speed, and a scanning track is controlled, whereby welding is effected with input heat amounts on both left and right sides with respect to the welding progressing direction being substantially different from each other.

### TECHNICAL FIELD

The present invention relates to laser welding and, in particular, to a laser welding method suitable for the laser welding of automotive components.

### BACKGROUND ART

Laser welding allows welding of deep penetration. As compared with the conventional arc welding, it allows more precise welding at higher speed, so that, in recent years, its use is expanding. It allows welding of deep penetration since, as compared with arc welding, etc., laser exhibits a higher power density. Thus, a metal to which a laser beam is applied is instantaneously fused and evaporated. Because of the high reaction force due to the evaporation, the fusion zone is pressed down, and a space called a keyhole is formed. The laser beam can reach the interior of the material via the keyhole, so that welding of deep penetration is attained. An automotive component is of a complicated structure. Further, due to the restrictions attributable to the structure of the production line, it frequently occurs that the laser beam cannot be applied vertically to the weld portion. In such cases, the laser beam application is effected obliquely, so that the actual depth of penetration and the effective welding length are different from each other. To attain a sufficient effective welding length in such cases, it is disadvantageously necessary to provide an excessively large amount of input heat. Further, in the case where the aiming position is deviated due to deviation in setting, there is involved a problem that the effective welding length undergoes a great change. To cope with the deviation of the aiming position, there has been proposed a method in which weaving of the laser beam is effected in the horizontal direction to thereby enlarge the welding width as disclosed in JP-1990-142690-A (Patent Document 1).

Another known example of a laser welding method is disclosed in JP-1998-71480-A (Patent Document 2). According to this laser welding method, a laser beam is condensed on galvanized steel plates superimposed one upon the other. While scanning a two-dimensional locus with the optical axis of the laser beam, welding is performed on the weld portions through successive movement of the beam. With respect to every direction around the optical axis of the laser beam as a reference axis, the scanning width is 0.2 times or more and 10 times or less the condensation spot of the laser beam. In the case where the scanning pattern is a circle or an ellipse, overlapping of the locus of the optical axis of the laser beam on the steel plates is kept within a fixed range (See the Abstract).

### PRIOR ART DOCUMENT

### Patent Documents

Patent Document 1: JP-1990-142690-A

Patent Document 2: JP-1998-71480-A

### SUMMARY OF THE INVENTION

### Problem to be Solved by the Invention

In the welding methods of Patent Document 1 and Patent Document 2, a beam scanning device causes the laser beam to perform reciprocating oscillation in a direction perpendicular to the welding direction, and, by using this laser beam performing reciprocating oscillation, the bead width of the bonding portion is increased, and an enhancement in tensile strength is achieved. By using this welding method for a butt joint, it is to be estimated that an improvement in terms of aiming position tolerance can be achieved. This welding method, however, cannot contribute to the securing of the effective welding length at the time of oblique application although it helps to achieve an improvement in terms of the tolerance of the deviation in the aiming position.

It is an object of the present invention to provide a laser welding method making it possible to secure the effective welding length when the laser beam is applied obliquely.

### Means for Solving the Problem

The present invention includes a plurality of means for solving the above problems. According to an example of the means, there is provided “a laser welding method in which oscillation scanning is periodically effected with a laser beam while moving an object of welding to apply the laser beam to a surface of the object of welding to perform welding, and in the method at least one of the output of the laser beam, a scanning speed, and a scanning track is controlled, whereby welding is effected with input heat amounts on both left and right sides with respect to the welding progressing direction being substantially different from each other.”

### Effect of the Invention

By adopting the laser welding method according to the present invention, it is possible to enlarge the welding width, achieving an improvement in terms of aiming position tolerance. Further, it is possible to increase the effective welding length in the case where the laser beam is applied obliquely.

Other objects, constructions, and effects of the invention will become apparent from the following description of embodiments.

### BRIEF DESCRIPTION OF DRAWINGS

FIG. 1 is a schematic diagram illustrating a laser welding apparatus according to embodiment 1.

FIG. 2A is a schematic diagram illustrating a laser scanning track and a molten pool according to embodiment 1.

FIG. 2B is a schematic diagram illustrating the sectional configuration of a weld portion in embodiment 1.

FIG. 3A is a schematic diagram illustrating a laser scanning track and a molten pool according to a comparative example as compared with the present invention.

FIG. 3B is a schematic diagram illustrating the sectional configuration of a weld portion in a comparative example as compared with the present invention.

FIG. 4 is a schematic diagram illustrating a laser welding apparatus according to embodiment 2.

FIG. 5A is a schematic diagram illustrating a laser scanning track and a molten pool according to embodiment 2.

FIG. 5B is a schematic diagram illustrating the sectional configuration of a weld portion in embodiment 2.

FIG. 6A is a schematic diagram illustrating a laser scanning track and a molten pool according to a comparative example as compared with the present invention.

FIG. 6B is a schematic diagram illustrating the sectional configuration of a weld portion in a comparative example as compared with the present invention.

FIG. 7 is a schematic diagram illustrating a laser welding apparatus according to embodiment 3.

FIG. 8A is a schematic diagram illustrating a laser scanning track and a molten pool according to embodiment 3.

FIG. 8B is a schematic diagram illustrating the sectional configuration of a weld portion in embodiment 3.

FIG. 9A is a schematic diagram illustrating a laser scanning track and a molten pool according to a comparative example as compared with the present invention.

FIG. 9B is a schematic diagram illustrating the sectional configuration of a weld portion in a comparative example as compared with the present invention.

FIG. 10 is a schematic diagram illustrating a laser welding apparatus according to embodiment 4.

FIG. 11A is a schematic diagram illustrating a laser scanning track and a molten pool according to embodiment 4.

FIG. 11B is a schematic diagram illustrating the sectional configuration of a weld portion in embodiment 4.

FIG. 12A is a schematic diagram illustrating a laser scanning track and a molten pool according to a comparative example as compared with the present invention.

FIG. 12B is a schematic diagram illustrating the sectional configuration of a weld portion in a comparative example as compared with the present invention.

FIG. 13 is a diagram illustrating the result of the investigation of the relationship between the welding condition and the weld portion configuration.

FIG. 14 is a schematic diagram illustrating the relationship between the scanning track of a laser beam and the rotational direction of an object of welding.

FIG. 15 is a chart in which symmetrical welding configuration and asymmetrical welding configuration are classified according to the ratio between the rotation diameter of laser rotational scanning and the input heat amount.

FIG. 16 is a sectional view of a fuel pump according to an embodiment of the present invention.

FIG. 17 is a sectional view of a fuel injection valve according to an embodiment of the present invention.

### MODES FOR CARRYING OUT THE INVENTION

In the following, embodiments of the present invention will be described with reference to the drawings.

### Embodiment 1

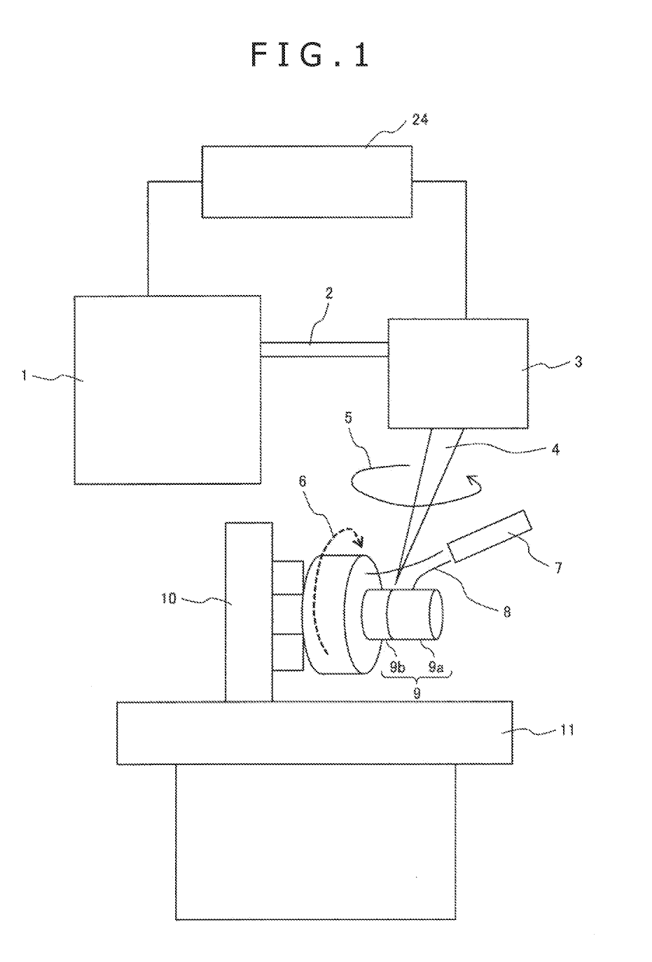

FIG. 1 is a schematic diagram illustrating a laser welding apparatus according to embodiment 1.

In FIG. 1, character 1 indicates a laser oscillator, character 2 indicates a laser optical fiber, character 3 indicates a galvanoscanner, character 4 indicates a laser beam, character 5 indicates a rotational direction of the laser beam, character 6 indicates a rotational direction of an object of welding (moving direction of the weld portion), character 7 indicates a shielding gas nozzle, character 8 indicates a shielding gas, character 9 indicates the object of welding, character 10 indicates a rotary spindle, character 11 indicates a processing stage, and character 24 indicates a control device.

In the present embodiment, the object of welding 9 is a fuel pump component, the material of which is 304 stainless steel. The laser beam 4 is a disk laser beam the wavelength of which is approximately 1030 nm. The scanning track of the laser beam 4 is a circle. The processing was performed with the laser beam 4 being inclined by 25 degrees. The shielding gas 8 is nitrogen gas.

The laser beam 4 generated in the laser oscillator 1 is sent to the galvanoscanner 3 via the laser optical fiber 2. The laser beam 4 is condensed by the galvanoscanner 3, and is applied to the object of welding 9. The object of welding 9 is fixed to a rotary spindle 10 and is rotated at a predetermined speed. The galvanoscanner 3 contains a galvanomirror. By varying the angle of the mirror, it is possible to control the application position of the laser beam 4. The welding joint is of a butt joint structure.

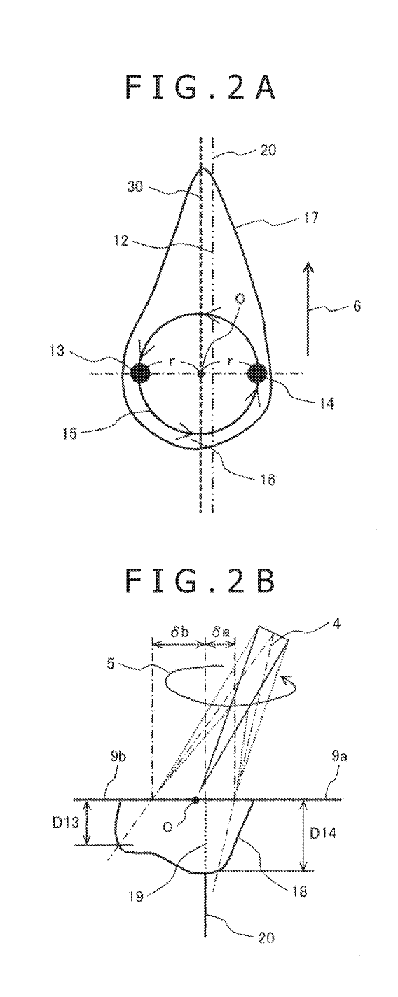

FIG. 2A is a schematic diagram illustrating a laser scanning track and a molten pool according to embodiment 1. FIG. 2B is a schematic diagram illustrating the sectional configuration of a weld portion in embodiment 1. The section of the weld portion of FIG. 2B is a section perpendicular to a weld line 12.

Character 12 indicates the weld line, character 13 indicates a low input heat side laser beam application position, character 14 indicates a high input heat side laser beam application position, character 15 indicates the laser scanning track, character 16 indicates the laser scanning direction, character 17 indicates a molten pool, character 18 indicates the sectional configuration of a weld portion, character 19 indicates the effective welding length (dotted-line portions), character 20 indicates a bonding surface, and character 30 indicates the locus through which the center O of the circular scanning track of the laser beam 4 passes. In the present embodiment, the welding joint is of a butt joint structure, so that, in FIG. 2A, the weld line 12 coincides with the bonding surface 20.

As shown in FIG. 2A, the laser beam 4 performs scanning so as to draw a circle of a diameter r around the center O. The object of welding 9 moves along the rotational direction 6, so that, when the laser beam 4 has made one round of the scanning track, it does not overlap the scanning track one round before. The application position of the laser beam 4 when it has made one round of the scanning track involves a deviation with respect to the application position one round before by a distance corresponding to the product of the moving speed of the object of welding 9 and the requisite time for the beam to make one round of the scanning track.

The welding is performed while rotating the laser beam 4 along the laser scanning track, so that, in relation to the rotational direction of the object of welding 9, there are formed in the molten pool 17 the low input heat side laser beam application position 13 and the high input heat side laser beam application position 14.

The high input heat side laser beam application position 14 is a position where the input heat amount to the object of welding 9 due to the laser beam application is large. In the circular scanning track, on the side where the tangential direction thereof is parallel to the moving direction of the object of welding 9 and of the same orientation therewith, the relative speed of the laser beam 4 and the object of welding 9 is low, so that the high input heat side laser beam application position 14 is formed. The low input heat side laser beam application position 13 is a position where the input heat amount to the object of welding 9 due to the laser beam application is small. On the side where the tangential direction of the scanning track is parallel to the moving direction of the object of welding 9 and of the opposite orientation, the relative speed of the laser beam 4 and the object of welding 9 is high, so that the low input heat side laser beam application position 14 is formed.

In the present embodiment, welding was performed while continuously rotating the laser beam 4 in a circle of a diameter of 2 mm. The proportion of the input heat amount between the low input heat side and the high input heat side was 1.1. The flow rate of the shielding gas was 50 L/min. The difference in the input heat amount within the molten pool 17 influences the weld portion sectional configuration 18. At the high input heat side laser beam application position 14, a deep penetration D14 is attained, and, at the low input heat side laser beam application position 13, a somewhat shallow penetration D13 is attained, resulting in an asymmetrical weld portion sectional configuration.

In the present embodiment, the laser beam application position is adjusted such that the depth of penetration is maximum at the portion of the bonding surface 20. As a result, it is possible to attain a maximum depth of penetration at the butt joint position between the two members to be bonded together, making it possible to effectively secure the effective welding length 19. In the present embodiment, the effective welding length 19 is equal to the penetration depth dimension D14.

In the present embodiment, to increase the effective welding length 19, the center O of the circular scanning track passes a locus 30. The locus 30 exists at a position spaced away from the bonding surface 20. The center O is set at a position deviated to the side (the object of welding 9b side) opposite the laser beam application side (galvanoscanner 3 side) with respect to the bonding surface 20. Thus, the deflection width 5a of the laser beam 4 on the object of welding 9a side is smaller than the deflection width 5b of the laser beam 4 on the object of welding 9b side.

The direction in which the center O is deviated from the bonding surface 20 and the deviation amount thereof vary in accordance with the radius r of the circular scanning track, the laser output (the depth of penetration), and the laser beam application angle. Thus, there can be a case where the center O is situated on the bonding surface 20.

Further, due to the sectional configuration 18 of the weld portion, the width of the weld portion is large, and if the laser beam application position is changed to the left or right, the effective welding length 19 is not easily changed, making it possible to perform a welding superior in robustness.

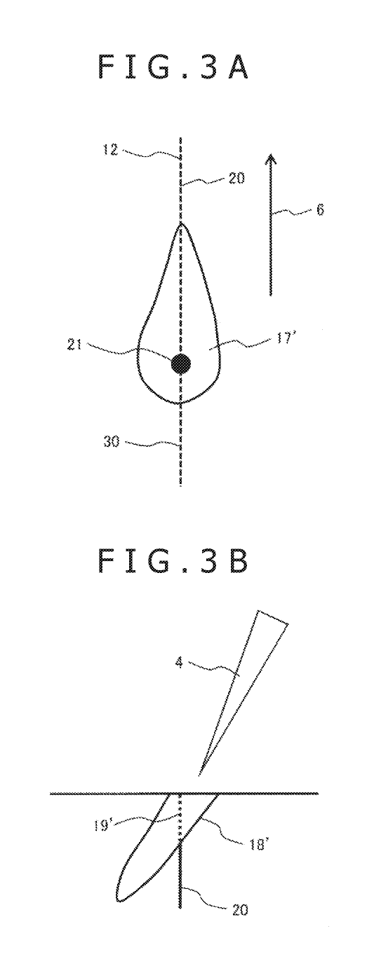

FIG. 3A is a schematic diagram illustrating a laser scanning track and a molten pool according to a comparative example as compared with the present invention. FIG. 3B is a schematic diagram illustrating the sectional configuration of a weld portion in a comparative example as compared with the present invention. The section of the weld portion of FIG. 3B is a section perpendicular to the weld line 12.

In FIG. 3A, character 21 indicates a laser beam application position. In this comparative example, the laser beam 4 is not rotated, so that the rotation radius r of the laser beam 4 is 0. As shown in FIG. 3A, in this case, the locus 30 through which the laser beam 4 passes coincides with the weld line 12 and the bonding surface 20.

In the case where the laser beam is not rotated, the width of the molten pool 17′ is smaller as compared with the case where it is rotated. Further, the weld portion sectional configuration 18′ is narrower and deeper. In the case of the present embodiment, welding is executed from an oblique direction, so that the effective welding length (dotted-line portion) 19′ is smaller than in the case where the laser beam is rotated. Further, in the case where the laser beam application position 21 is deviated to the left or right, the effective welding length 19′ is easily changed. Thus, a welding process as shown in FIGS. 3A and 3B is undesirable from the viewpoint of production. A shortage of welding penetration may result in a fatal defect of the product. While in the comparative example of FIG. 3A the locus 30 through which the laser beam 4 passes coincides with the weld line 12 and the bonding surface 20, it may be set at a position deviated to the laser beam application side in order to increase the effective welding length 19′. However, the bead width is small, so that if the deviation amount is large, there is a fear of the bonding surface on the surface of the object of welding becoming incapable of being welded. Thus, it is to be assumed that a welding process which helps to efficiently secure the effective welding length 19 and which is superior in robustness as in the case of the present embodiment is very useful.

While in the present embodiment the present invention is applied to butt welding, the structure of the weld portion joint is not restricted thereto. Further, in the present embodiment, the difference in the relative speed between the left and right sides with respect to the weld line 12 due to the laser rotational scanning is utilized. Apart from this, by varying the laser output, it is possible to increase the difference between the left and right input heat amounts. The laser rotational scanning or the change in the laser output is executed by controlling the galvanoscanner 3 or the laser oscillator 1 by a control device 24.

The control device 24 is a device controlling the laser output, the laser scanning speed and the laser scanning track. To carry out the present invention, it is necessary to control the laser output, the laser scanning speed, and the laser scanning track in synchronism with each other. The laser rotational scanning is executed by controlling the galvanoscanner 3 by the control device 24. The change in the laser output is executed by controlling the laser oscillator 1 by the control device 24.

The control device 24 has a function to compute the laser beam application position, and can vary the laser output and the laser scanning speed in accordance with the laser beam application position. Further, by previously programming the laser output, the laser scanning speed, and the laser scanning track and starting them simultaneously, it is possible to execute a synchronous operation. That is, the laser output may be varied by controlling the laser oscillator 1 by the control device 24 while performing the laser rotational scanning by controlling the galvanoscanner 3 by the control device 24. On the side where the input heat amount to the object of welding 9 is large because of the relationship between the laser rotational scanning and the moving direction of the object of welding 9, it is possible to further increase the laser output to increase the input heat amount. Or, on the side where the input heat amount to the object of welding 9 is small because of the relationship between the laser rotational scanning and the moving direction of the object of welding 9, it is possible to further decrease the laser output to decrease the input heat amount. Or, on the side where the input heat amount to the object of welding 9 is large because of the relationship between the laser rotational scanning and the moving direction of the object of welding 9, it is possible to reduce the laser output to decrease the input heat amount, thereby diminishing the difference in input heat amount between the left and right sides. Or, on the side where the input heat amount to the object of welding 9 is small because of the relationship between the laser rotational scanning and the moving direction of the object of welding 9, it is possible to increase the laser output to increase the input heat amount, thereby diminishing the difference in input heat amount between the left and right sides.

Further, the kind of laser beam, the material of the object of welding, the kind of shielding gas, and the laser welding condition are not restricted to those mentioned above. It is possible to employ different kinds of laser beam, material of the welding object, shielding gas, and laser welding condition.

### Embodiment 2

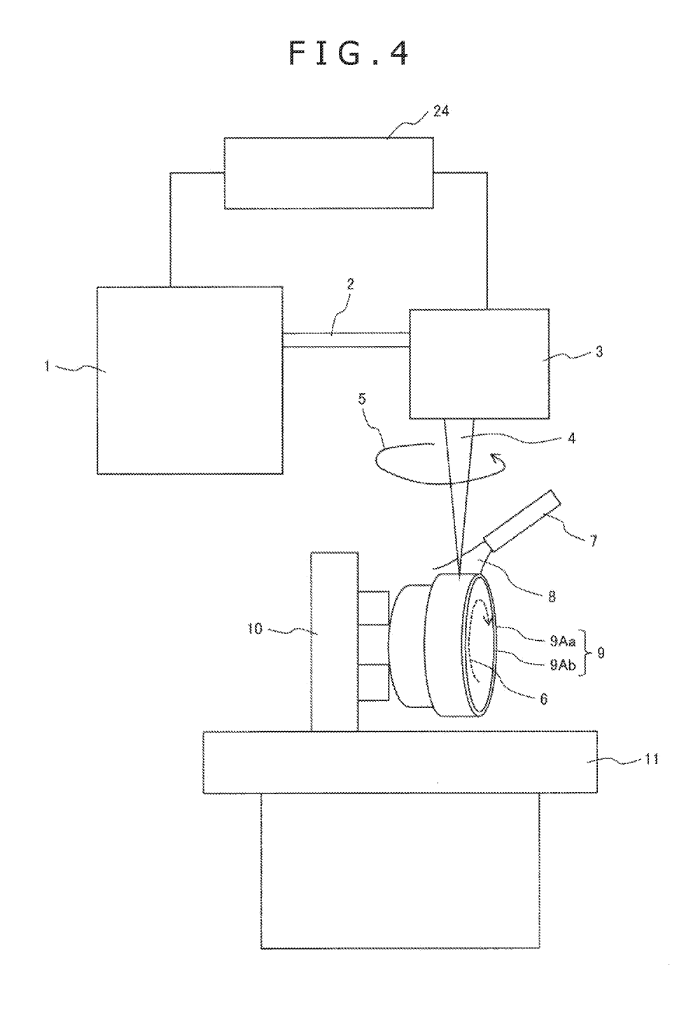

Embodiment 2 of the present invention will be described with reference to FIGS. 4 through 6B. In the drawings, the components that are the same as those of embodiment 1 are indicated by the same reference characters. A description of the components that are the same as those of embodiment 1 will be left out.

FIG. 4 is a schematic diagram illustrating a laser welding apparatus according to embodiment 2.

In the present embodiment, the object of welding 9A is different from that of embodiment 1. The object of welding 9A is a fuel injection part, and its material is 304 stainless steel. The laser beam 4 is a disk laser beam of a wavelength of approximately 1030 nm. The scanning track of the laser beam 4 is a circle. The laser beam 4 is applied from a direction perpendicular to the object of welding 9 to perform the processing. As in embodiment 1, the shielding gas 8 is nitrogen gas.

The object of welding 9A is fixed to a rotary spindle 10, and is rotated at a predetermined speed. As described in connection with embodiment 1, the application position of the laser beam 4 can be controlled by operating the galvanoscanner 3 by the control device 24. The welded joint constituting the object of welding 9A (9Aa, 9Ab) is of the lap welding structure.

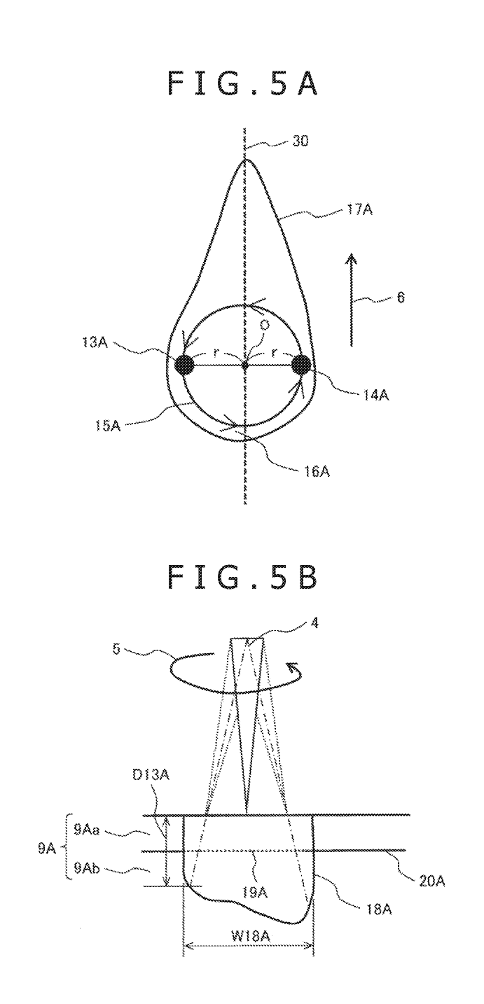

FIG. 5A is a schematic diagram illustrating a laser scanning track and a molten pool according to embodiment 2. FIG. 5B is a schematic diagram illustrating the sectional configuration of a weld portion in embodiment 2. The section of the weld portion of FIG. 5B is a section perpendicular to the rotational direction (moving direction) 6.

In FIGS. 5A and 5B, character 13A indicates a low input heat side laser beam application position, character 14A indicates a high input heat side laser beam application position, character 15A indicates the laser scanning track, character 16A indicates the laser scanning direction, character 17A indicates a molten pool, character 18A indicates the sectional configuration of the weld portion, character 19A indicates the effective welding length (dotted-line portion), and character 20A indicates the bonding surface.

The welded joint of the present embodiment is of the lap welding structure. Thus, the effective welding length 19A is obtained in a direction which is perpendicular to the locus 30 through which the center O of the circular scanning track of the laser beam 4 passes and which is parallel to the bonding surface 20.

In the present embodiment, the laser scanning track 15A, the laser scanning direction 16A, and the rotational direction 6 of the object of welding 9A are the same as those of embodiment 1. As in embodiment 1, because of the rotational direction of the object of welding 9, by performing welding while rotating the laser beam 4 along the laser scanning track, there are formed in the molten pool 17 the low input heat side laser beam application position 13 and the high input heat side laser beam application position 14.

In the present embodiment, welding was performed while rotating the laser beam 4 continuously in a circle of a diameter of 0.8 mm. The proportion of the input heat amount between the low input heat side and the high input heat side was 1.2. The flow rate of the shielding gas was 50 L/min. The difference in the input heat amount within the molten pool 17A influences the weld portion sectional configuration 18A. At the high input heat side laser beam application position 14A, a deep penetration is attained, and, at the low input heat side laser beam application position 13A, a somewhat shallow penetration is attained, resulting in an asymmetrical weld portion sectional configuration.

In the present embodiment, the depth of penetration D13A at the low input heat side laser beam application position 13A is deeper than the bonding surface 20A. As a result, the effective welding length 19A is attained over the entire width W18A of the weld portion sectional configuration 18A. Thus, it is possible to provide a welded joint the width of the effective welding length 19A of which is large and which is superior in bonding strength.

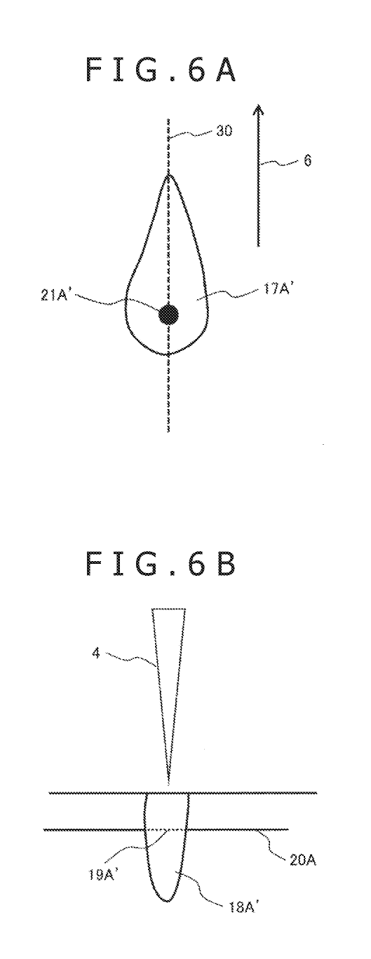

FIG. 6A is a schematic diagram illustrating a laser scanning track and a molten pool according to a comparative example as compared with the present invention. FIG. 6B is a schematic diagram illustrating the sectional configuration of a weld portion in a comparative example as compared with the present invention. The section of the weld portion in FIG. 6B is a section perpendicular to the rotational direction (moving direction) 6.

In FIG. 6A, character 21A′ indicates the laser beam application position. In this comparative example, the laser beam 4 is not rotated, so that, in this case, the rotation radius r of the laser beam 4 is 0.

In the case where the laser beam is not rotated, the width of the molten pool 17A′ is smaller as compared with the case where it is rotated. Further, the weld portion sectional configuration 18A′ is narrower and deeper. In the case of the present embodiment, the effective welding length (dotted-line portion) 19A′ is smaller than in the case where the laser beam is rotated. In the case where the effective welding length 19A′ is not sufficient, it is necessary, for example, to lower the welding speed, and that can result in an inefficient welding process. Thus, it is to be assumed that a welding process which helps to efficiently secure the effective welding length 19A as in the case of the present embodiment is very useful.

While the present embodiment is applied to lap welding, the weld portion joint structure is not restricted thereto. Further, in the present embodiment, the difference in relative speed between the left and right sides with respect to the locus 30 of the laser rotational scanning is utilized. Apart from this, as described in connection with embodiment 1, by varying the laser output, it is possible to increase or reduce the difference in the input heat amount between the left and right sides. Such a welding process can be executed as in the case described in connection with embodiment 1. Further, in the present embodiment, the kind of laser beam, the material of the object of welding, the kind of shielding gas, and the laser welding condition are not restricted to those mentioned above. It is possible to employ different kinds of laser beam, material of the welding object, shielding gas, and laser welding condition.

### Embodiment 3

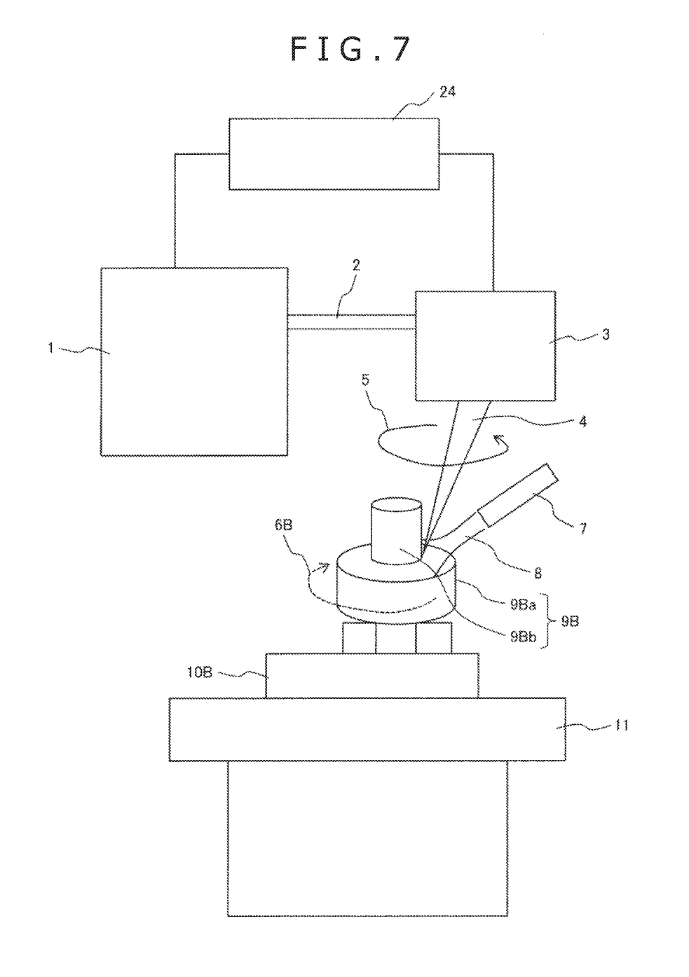

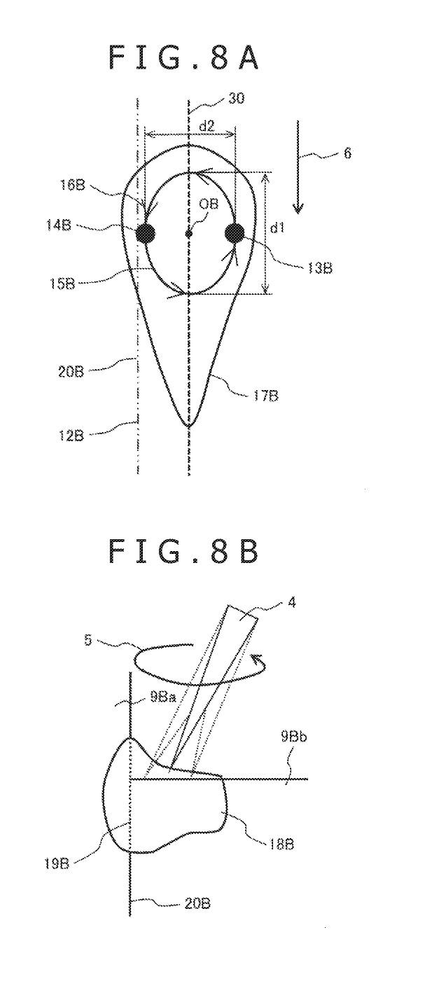

Embodiment 3 of the present invention will be described with reference FIGS. 7 through 9B. In the drawings, the components that are the same as those of embodiments 1 and 2 are indicated by the same reference characters. A description of the components that are the same as those of embodiments 1 and 2 will be left out.

FIG. 7 is a schematic diagram illustrating a laser welding apparatus according to embodiment 3.

In the present embodiment, the object of welding 9B is different from that of embodiments 1 and 2. Since the object of welding 9B is different from that of embodiments 1 and 2, the arrangement of the rotary spindle 10B is different from that of embodiments 1 and 2. In embodiments 1 and 2, the rotation axis of the rotary spindle 10B is provided in the horizontal direction, whereas, in the present embodiment, the rotation axis of the rotary spindle 10B is provided in the vertical direction. The direction of the rotation axis of the rotary spindle 10B, however, is varied in accordance with the application direction of the laser beam 4, so that, by varying the application direction of the laser beam 4, it is also possible to provide the direction of the rotation axis of the rotary spindle 10B in a direction different from the vertical direction.

In the present embodiment, the object of welding 9B is a fuel pump part, and its material is 304 stainless steel. The laser beam 4 is a disk laser beam of a wavelength of approximately 1030 nm. The scanning track of the laser beam 4 is a circle. The laser beam 4 is applied from a direction inclined by 10 degrees to perform the processing. As in embodiment 1, the shielding gas 8 is nitrogen gas.

In the present embodiment, the object of welding 9B (9Ba, 9Bb) is fixed to a rotary spindle 10B having a rotation axis arranged in the vertical direction, and is rotated at a predetermined speed. As described in connection with embodiment 1, the application position of the laser beam 4 can be controlled by operating the galvanoscanner 3 by the control device 24. The weld portion joint structure is a fillet weld joint.

FIG. 8A is a schematic diagram illustrating a laser scanning track and a molten pool according to embodiment 3. FIG. 8B is a schematic diagram illustrating the sectional configuration of a weld portion in embodiment 3. The section of the weld portion in FIG. 8B is a section perpendicular to the weld line 12B.

In FIGS. 8A and 8B, character 12B indicates the weld line, character 13B indicates a low input heat side laser beam application position, character 14B indicates a high input heat side laser beam application position, character 15B indicates the laser scanning track, character 16B indicates the laser scanning direction, character 17B indicates a molten pool, character 18B indicates the sectional configuration of the weld portion, character 19B indicates the effective welding length (dotted-line portion), and character 20B indicates the bonding surface.

In fillet weld, caused to abut substantially perpendicularly the plane of one object of welding 9Ba is the other object of welding 9Bb, and two faces substantially orthogonal to each other are welded together. In this case, the laser beam 4 is applied to the object of welding 9Bb abutting the plane of the object of welding 9Ba substantially perpendicularly. Also in the present embodiment, welding is performed while rotating the laser beam 4 along the laser scanning track. More specifically, the laser beam 4 is rotated so as to draw an ellipse having a major axis (long axis) d1 and a minor axis (short axis) d2 (d1>d2). At this time, because of the rotational direction (moving direction) 6 of the object of welding 9B, there is formed in the molten pool 17B the low input heat side laser beam application position 13B and the high input heat side laser beam application position 14B.

In the present embodiment, the welded joint structure is a fillet, so that, in FIG. 8A, the weld line 12B coincides with the bonding surface 20B. Further, as shown in FIG. 2A, the locus 30 is parallel to the weld line 12B and the bonding surface 20B. In the present embodiment, the scanning track of the laser beam 4 is an ellipse. In this case 30, the locus 30 is a locus through which the point of intersection OB of the major axis and the minor axis of the ellipse passes.

In the fillet weld of the present embodiment, a deep penetration is formed at the portion of the bonding surface 20B. In view of this, the high input heat side laser beam application position 14B is situated on the side of the end portion of the object of welding 9Bb welded to the object of welding 9Ba with respect to the low input heat side laser beam application position 13B. This arrangement is set by the laser scanning direction 16B and the rotational direction 6 of the object of welding 9B. That is, the laser beam 4 is applied to the object of welding 9B while drawing an elliptical track 15B on the side of the end portion of the object of welding 9Bb welded to the object of welding 9Ba such that the laser scanning direction 16B is the same direction as the rotational direction 6 of the object of welding 9B. Further, by making the laser scanning track 15B an elliptical track, it is possible to increase the input heat amount in the vicinity of the bonding surface 20B.

In the present embodiment, welding was performed while continuously rotating the laser beam 4 in an ellipse having a major axis of 3 mm and a minor axis of 2 mm. More specifically, scanning is performed with the laser beam 4 in an elliptical track having a major axis in the welding progressing direction and a minor axis in a direction perpendicular to the welding progressing direction. The flow rate of the shielding gas was 50 L/min. The difference in the input heat amount within the molten pool 17B influences the weld portion sectional configuration 18B. At the high input heat side laser beam application position 14B, a deep penetration is attained, and, at the low input heat side laser beam application position 13B, a somewhat shallow penetration is attained, resulting in an asymmetrical weld portion sectional configuration sectional configuration 18B.

In the present embodiment, the proportion of the input heat amount between the low input heat side 13B and the high input heat side 14B was 1.1 times. In the present embodiment, the laser beam application position is adjusted such that the high input heat side laser beam application position 14B is on the fillet side, whereby in the fillet abutment position, a maximum depth of penetration is attained, making it possible to effectively secure the effective welding length 19B. Further, due to the sectional configuration 18B of the weld portion, the width of the weld portion is large, and if the laser beam application position is changed to the left or right, the effective welding length 19B is not easily changed. Thus, the welding process of the present embodiment makes it possible to realize a welding superior in robustness.

When operating the laser beam 4 in an elliptical track, scanning may be performed in an elliptical track having a minor axis in the welding progressing direction and a major axis in a direction perpendicular to the welding progressing direction. Further, the scanning track of the laser beam 4 may be a circle.

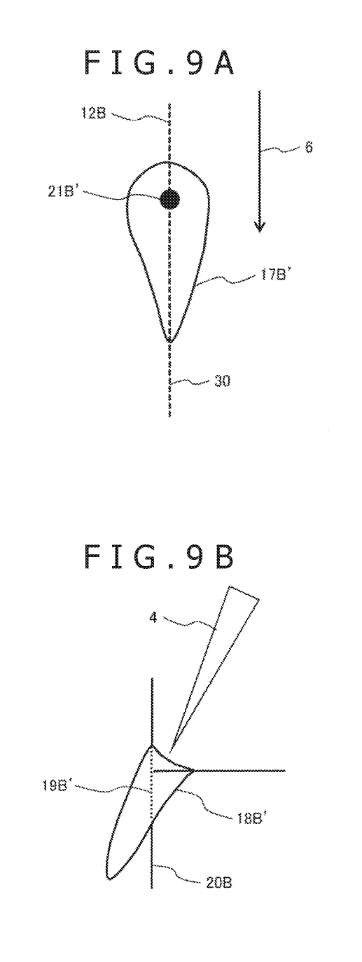

FIG. 9A is a schematic diagram illustrating a laser scanning track and a molten pool according to a comparative example as compared with the present invention. FIG. 9B is a schematic diagram illustrating the sectional configuration of a weld portion in a comparative example as compared with the present invention. The section of the weld portion of FIG. 9B is a section perpendicular to the weld line 12B.

In FIG. 9A, character 21B′ indicates a laser beam application position. In this comparative example, the laser beam 4 is not rotated, so that the rotation radius r of the laser beam 4 is 0. As shown in FIG. 9A, in this case, the locus 30 through which the laser beam 4 passes coincides with the weld line 12B and the bonding surface 20B.

In the case where the laser beam is not rotated, the width of the molten pool 17B′ is smaller as compared with the case where it is rotated. Further, the weld portion sectional configuration 18B′ is narrower and deeper. In the case of the present embodiment, welding is executed from an oblique direction, so that the effective welding length (dotted-line portion) 19B′ is smaller than in the case where the laser beam is rotated. Further, in the case where the laser beam application position 21 B′ is deviated to the left or right, the effective welding length 19B′ is easily changed. Thus, a welding process as shown in FIGS. 9A and 9B is undesirable from the viewpoint of production. A shortage of welding penetration may result in a fatal defect of the product. Thus, it is to be assumed that a welding process which helps to efficiently secure the effective welding length 19B and which is superior in robustness as in the case of the present embodiment is very useful.

While in the present embodiment the present invention is applied to fillet weld, the weld portion joint structure is not restricted thereto. Further, in the present embodiment, there is utilized the difference in relative speed between the left and right sides with respect to the weld line 12B due to the laser rotational scanning. Apart from this, as described in connection with embodiment 1, by varying the laser output, it is possible to increase or reduce the difference in the input heat amount between the left and right sides. Further, in the present embodiment, the kind of laser beam, the material of the object of welding, the kind of shielding gas, and the laser welding condition are not restricted to those mentioned above. It is possible to employ different kinds of laser beam, material of the welding object, shielding gas, and laser welding condition.

### Embodiment 4

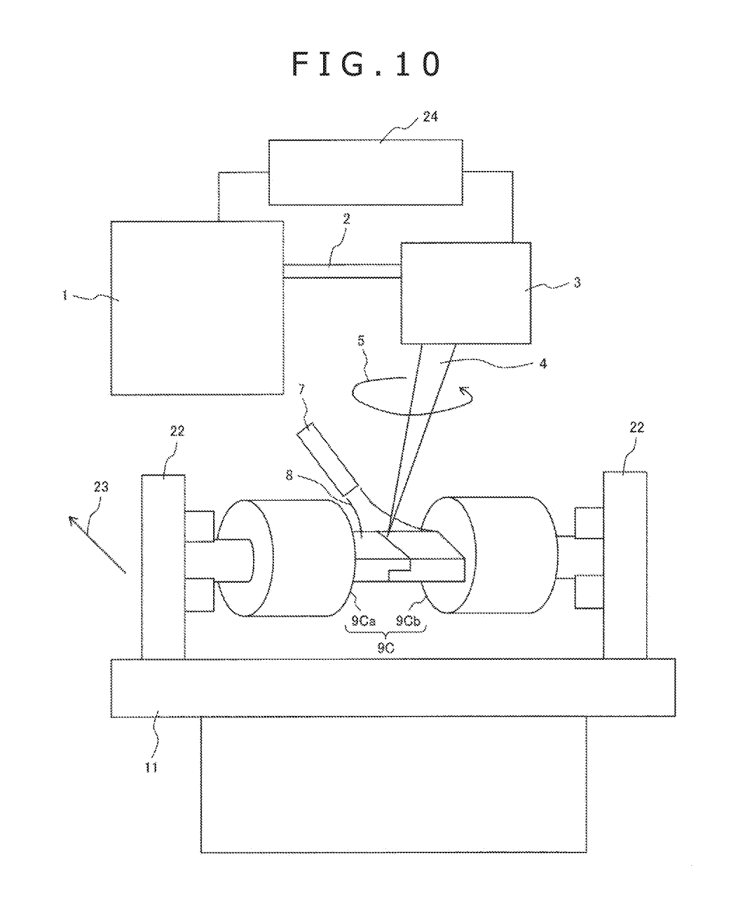

Embodiment 4 of the present invention will be described with reference to FIGS. 10 through 12B. In the drawings, the components that are the same as those of embodiments 1 through 3 are indicated by the same reference characters. A description of the components that are the same as those of embodiments 1 through 3 will be left out.

FIG. 10 is a schematic diagram illustrating a laser welding apparatus according to embodiment 4.

In the present embodiment, the object of welding 9C (9Ca, 9Cb) is different from those of embodiments 1 through 3. Further, in the present embodiment, a fixation jig 22 is employed instead of the rotary spindle 10, 10B. Character 23 indicates the moving direction of the processing stage 11.

In the present embodiment, the object of welding 9C is an automotive component, the material of which is carbon steel. The laser beam 4 is a fiber laser beam the wavelength of which is approximately 1070 nm. The scanning track of the laser beam 4 is a circle. The processing is performed with the laser beam 4 inclined by 15 degrees. The shielding gas 8 is argon gas.

The object of welding 9 is fixed to the fixation jigs 22, and welding is executed while moving the processing stage 11 at a predetermined speed. As described in connection with embodiment 1, the application position of the laser beam 4 can be controlled by operating the galvanoscanner 3 by the control device 24. The welded joint structure is a fitting butt joint structure.

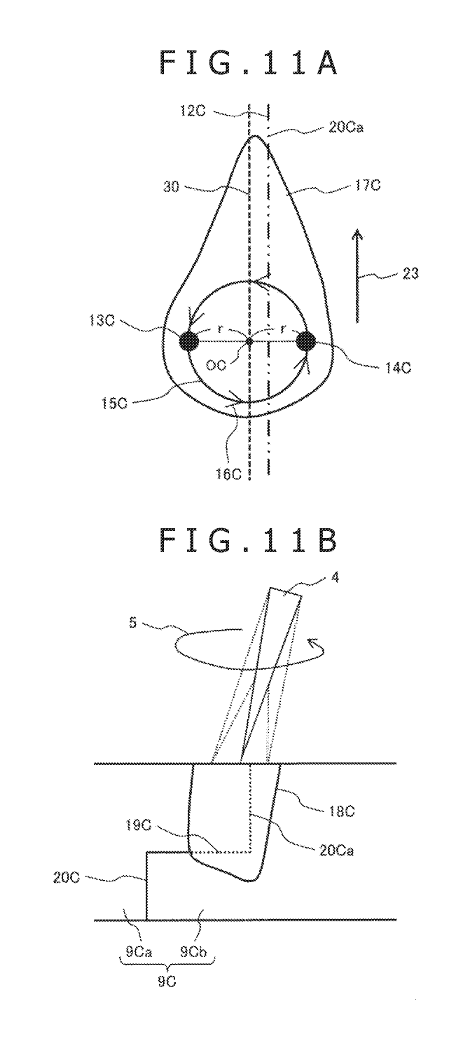

FIG. 11A is a schematic diagram illustrating a laser scanning track and a molten pool according to embodiment 4. FIG. 11B is a schematic diagram illustrating the sectional configuration of a weld portion in embodiment 4. In FIG. 11B, the weld portion section is a section perpendicular to the weld line 12C.

In FIGS. 11A and 11B, character 12C indicates the weld line, character 13C indicates the low input heat side laser beam application position, character 14C indicates the high input heat side laser beam application position, character 15C indicates the laser scanning track, character 16C indicates the laser scanning direction, character 17C indicates the molten pool, character 18C indicates the weld portion sectional configuration, character 19C indicates the effective welding length (dotted-line portion), character 20C indicates the bonding surface, and character 20Ca indicates the bonding surface appearing on the laser beam application surface side.

In the present embodiment, the welded joint structure is a fitting butt joint structure, so that, in FIG. 11A, the weld line 12C coincides with the bonding surface 20Ca. As in embodiment 1, the locus 30 is a locus through which the center O of the circular scanning track of the laser beam 4 passes.

Welding is performed while rotating the laser beam 4 along the laser scanning track 15C. At this time, because of the proceeding direction of the object of welding 9C, there are formed in the molten pool 17C the low input heat side laser beam application position 13C and the high input heat side laser beam application position 14C.

In the present embodiment, welding was performed while continuously rotating the laser beam 4 in a circle of a diameter of 1.6 mm. Further, the application position of the laser beam 4 was adjusted such that the bonding surface 20Ca is situated between the high input heat side laser beam application position 14C and the locus 30. That is, in the present embodiment, the high input heat side 14C is arranged on the object of welding 9Cb side. The locus 30 is arranged on the object of welding 9Ca side so as to pass the side opposite the high input heat side 14C with respect to the weld line 12C. In the present embodiment, the proportion of the input heat amount between the low input heat side 13C and the high input heat side 14C was 1.1 times.

The flow rate of the shielding gas was 50 L/min. The difference in the input heat amount within the molten pool 17C influences the weld portion sectional configuration 18C. At the high input heat side laser beam application position 14C, a deep penetration is attained, and, at the low input heat side laser beam application position 13C, a somewhat shallow penetration is attained, resulting in an asymmetrical weld portion sectional configuration 18C.

In the present embodiment, the laser beam application position is adjusted such that the bonding surface 20Ca is situated between the high input heat side laser beam application position 14C and the locus 30, whereby a maximum penetration depth was attained at the butt position 20Ca. The laser beam application position is adjusted by the position of the locus 30. The positional relationship between the locus 30 and the butt position 20Ca varies in accordance with the laser output and the diameter (or the radius) of the laser scanning track 15C.

Further, due to the rotation of the laser beam 4, the welding width is large, so that it is possible to efficiently secure the effective welding length 19C. Further, due to the large width of the weld portion, if the laser beam application position is changed to the left or right, the effective welding length 19 is not easily changed. Thus, the welding process of the present embodiment makes it possible to realize a welding superior in robustness.

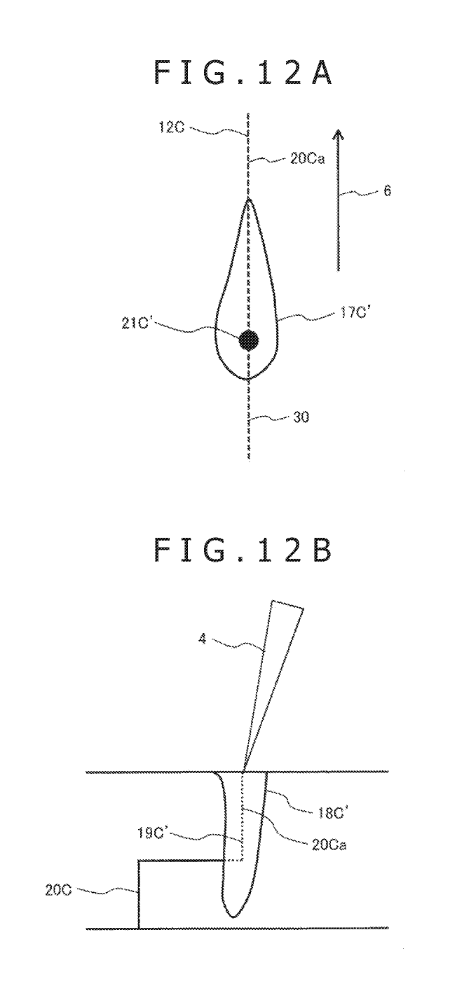

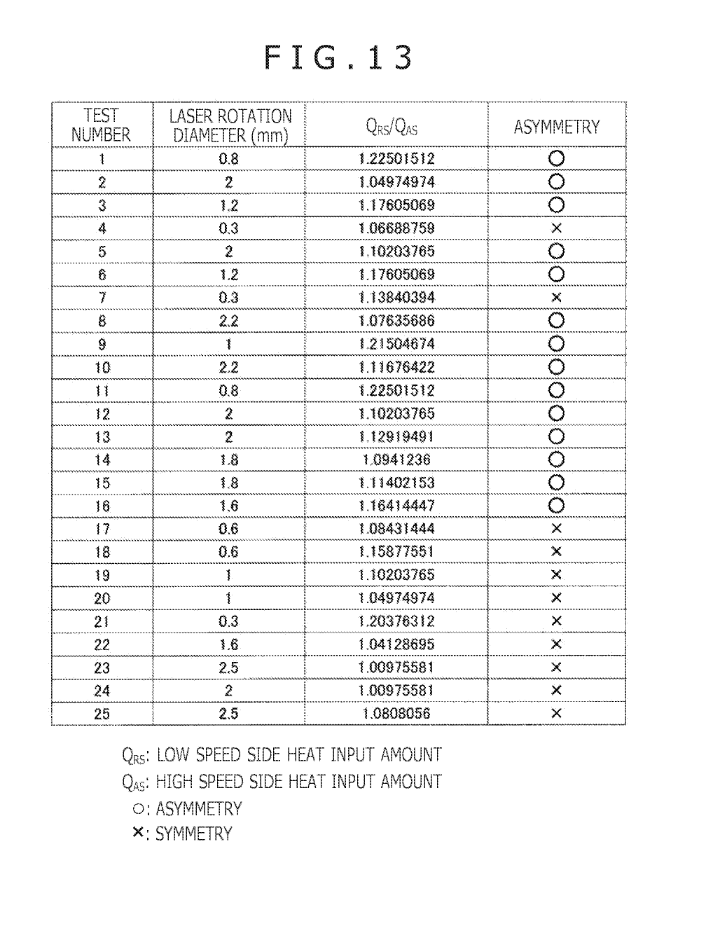

FIG. 12A is a schematic diagram illustrating a laser scanning track and a molten pool according to a comparative example as compared with the present invention. FIG. 12B is a schematic diagram illustrating the sectional configuration of a weld portion in a comparative example as compared with the present invention. The weld portion section in FIG. 12B is a section perpendicular to the weld line 12C.

In FIG. 12A, character 21C′ indicates a laser beam application position. In this comparative example, the laser beam 4 is not rotated, so that the rotation radius r of the laser beam 4 is 0. As shown in FIG. 12A, in this case, the locus 30 through which the laser beam 4 passes coincides with the weld line 12C and the bonding surface 20Ca.

In the case where the laser beam 4 is not rotated, the width of the molten pool 17C′ is smaller as compared with the case where it is rotated. Further, the weld portion sectional configuration 18C′ is narrower and deeper. In the case of the present embodiment, the width of the weld portion is small, so that the effective welding length (dotted-line portion) 19C′ is smaller than in the case where the laser beam is rotated. Further, in the case where the laser beam application position 21C′ is deviated to the right or left, the effective welding length 19C′ is easily changed. Thus, a welding process as shown in FIGS. 12A and 12B is undesirable from the viewpoint of production. A shortage of welding penetration may result in a fatal defect of the product. Thus, it is to be assumed that a welding process which helps to efficiently secure the effective welding length 19C and which is superior in robustness as in the case of the present embodiment is very useful.

While in the present embodiment the present invention is applied to fitting butt welding, the weld portion joint structure is not restricted thereto. Further, in the present embodiment, there is utilized the difference in relative speed between the left and right sides with respect to the weld line due to the laser rotational scanning. Apart from this, as described in connection with embodiment 1, by varying the laser output, it is possible to increase or reduce the difference in the input heat amount between the left and right sides. Further, in the present embodiment, the kind of laser beam, the material of the object of welding, the kind of shielding gas, and the laser welding condition are not restricted to those mentioned above. It is possible to employ different kinds of laser beam, material of the welding object, shielding gas, and laser welding condition.

### Embodiment 5

With respect to the butt weld portion of embodiment 1, the welding condition was varied to inspect the presence/absence of asymmetry in the weld portion sectional configuration. FIG. 13 is a diagram illustrating the result of the investigation of the relationship between the welding condition and the weld portion configuration.

FIG. 13 shows the relationship between the welding condition and the presence/absence of asymmetry in the weld portion sectional configuration. In test Nos. 1 through 25, the presence/absence of asymmetry was inspected with respect to each combination of the laser beam rotation diameter and the input heat amount ratio (Q_{RS}/Q_{AS}). Symbol Q_{RS} indicates the input heat amount on the side where the relative speed is lower, and symbol Q_{AS} indicates the input heat amount on the side where the relative speed is higher. In the case where there is asymmetry, symbol “o” is put in the asymmetry column. This result is regarded to be within the category of the embodiments of the present invention. In the case where there is no asymmetry, symbol “x” is put in the asymmetry column. This result is regarded to be out of the category of the present invention (comparative example).

The input heat amounts on both the left and right sides with respect to the welding progressing direction are substantially different from each other, whereby asymmetry is generated in the weld portion sectional configuration. The position of the deepest penetration does not coincide with the center of the weld bead surface. Here, the right-left direction is a direction perpendicular to the welding progressing direction (the locus 30 direction) and parallel to the surface of the object of welding.

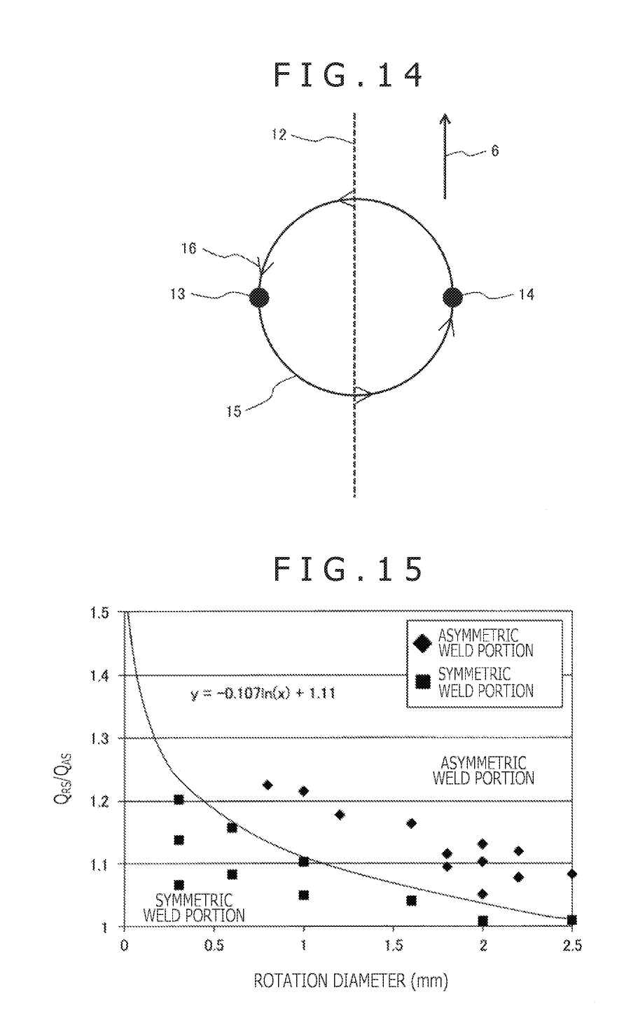

FIG. 14 is a schematic diagram illustrating the relationship between the scanning track of a laser beam and the rotational direction of an object of welding.

In this case, because of the relationship between the rotational direction of the object of welding and the laser rotational scanning direction, there are formed the low input heat side laser beam application position 13 and the high input heat side laser beam application position 14.

More specifically, in the circular track, on the side where the moving direction of the laser beam 4 and the moving direction of the object of welding are the same, the input heat amount due to the laser beam 4 is large. On the side where the moving direction of the laser beam 4 and the moving direction of the object of welding are opposite, the input heat amount due to the laser beam 4 is small. The magnitude of the input heat amount is a relative relationship between the low input heat side laser beam application position 13 and the high input heat side laser beam application position 14. Further, the input heat amount at the high input heat side laser beam application position 14 is larger than the input heat amount at an intermediate position between the low input heat side laser beam application position 13 and the high input heat side laser beam application position 14. On the other hand, the input heat amount at the low input heat side laser beam application position 13 is smaller than the input heat amount at the intermediate position between the low input heat side laser beam application position 13 and the high input heat side laser beam application position 14.

Based on this difference in the input heat amount, there is formed a one-sidedness in the depth of penetration. Further, it also influences the rotation diameter of the laser rotational scanning. For example, in the case where the rotation diameter is small, the difference in input heat amount is mostly lost due to heat conduction, so that the one-sidedness in the depth of penetration is not formed.

In view of this, classification in the symmetry/asymmetry of the weld portion was made based on the rotation diameter and the input heat amount ratio (Q_{RS}/Q_{AS}). FIG. 15 shows the classification result. FIG. 15 is a chart in which symmetrical welded configuration and asymmetrical welded configuration are classified according to the ratio between the rotation diameter of laser rotational scanning and the input heat amount.

It can be seen from the chart that the larger the input heat amount ratio, the more likely is the weld portion to be asymmetrical. When an approximate curve with respect to the upper limit in the case where a symmetrical weld portion is attained is obtained from this chart, equation (1) results.

y=−0.107 ln(x)+1.11 (1)

Thus, in the rotation diameter range of 2.5 mm or less, the relationship of formula (2) results with respect to the input heat amount ratio (Q_{RS}/Q_{AS}).

Q_{RS}/Q_{AS}>−0.107 ln (rotation diameter)+1.11 (2)

By selecting the welding condition so as to satisfy the relationship of formula (2), it is possible to obtain an asymmetrical weld portion.

While in the present embodiment the laser scanning track is a circle, the same idea is also applicable to the case where the locus is an ellipse. In the case where the major axis direction of the ellipse coincides with the rotational direction of the object of welding (welding progressing direction), the welding condition is selected so as to satisfy the relationship of formula (3).

Q_{RS}/Q_{AS}>−0.107 ln (minor axis)+1.11 (3)

In the case where the minor axis direction coincides with the rotational direction of the object of welding, the welding condition is selected so as to satisfy the relationship of formula (4).

Q_{RS}/Q_{AS}>−0.107 ln (major axis)+1.11 (4)

While the present embodiment is applied to a butt weld portion, the present relationship is applicable independently of the weld portion. The unit for the rotation diameter, the minor axis, and the major axis is [mm].

### Embodiment 6

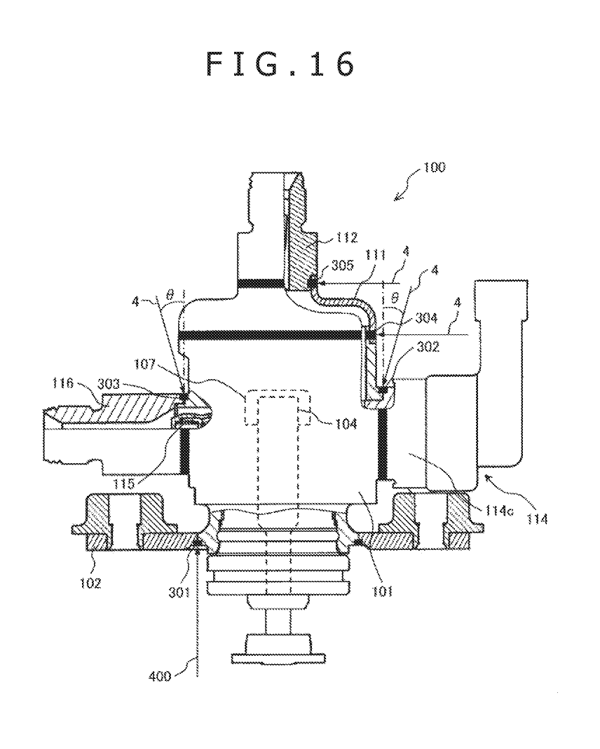

An example in which the present invention is applied to a high pressure fuel supply pump 100 will be described with reference to FIG. 16. FIG. 16 is a sectional view of a fuel pump according to an embodiment of the present invention.

The high pressure fuel supply pump 100 is a pump supplying a fuel pumped up from a fuel tank by a feed pump (not shown) to a fuel injection valve at high pressure. The high pressure fuel supply pump 100 is used in an internal combustion engine (engine) mounted in a vehicle. In the following description, the high pressure fuel supply pump 100 will be referred to as the pump 100.

A pressurization chamber 107 is formed in a pump main body 101, and the upper end portion (distal end portion) of a plunger 104 is inserted into the pressurization chamber 107. The plunger 104 makes a reciprocating motion within the pressurization chamber 107 to pressurize the fuel.

The pump main body (pump housing) 101 has a mounting flange 102 for fixation to the engine. The entire periphery of the mounting flange 102 is welded to the pump main body 101 through laser welding. A weld portion 301 between the mounting flange 102 and the pump main body 101 will be referred to as the first weld portion.

The pump main body 101 is provided with a suction valve mechanism 114 and a delivery valve mechanism 115. A body 114c of the suction valve mechanism 114 is fixed to the pump main body 101 through laser welding. This weld portion 302 will be referred to as the second weld portion. At the second weld portion 302, the entire outer periphery of the body 114c of the suction valve mechanism 114 is welded. On the downstream side of the delivery valve mechanism 115, there is provided a delivery joint 116. The delivery joint 116 is fixed to the pump main body 101 through laser welding. This weld portion 303 will be referred to as the third weld portion. At the third weld portion 303, the entire outer periphery of the delivery joint 116 is welded.

A damper cover 111 is mounted to the upper portion of the pump main body 101. The damper cover 111 is fixed to the pump main body 101 through laser welding. This weld portion 304 will be referred to as the fourth weld portion. The fourth weld portion 304 is welded over the entire periphery.

A suction joint 112 is fixed to the damper cover 111 through laser welding. This weld portion 305 will be referred to as the fifth weld portion. At the fifth weld portion 305, the entire outer periphery of the suction joint 112 is welded.

The welding joints of the first weld portion 301, the second weld portion 302, and the third weld portion 303 are of the butt welding structure, and the first weld portion 301, the second weld portion 302, and the third weld portion 303 are welded by the welding process of embodiment 1. At the first weld portion 301, the laser beam 4 is applied perpendicularly to the surface of the object of welding. At the second weld portion 302 and the third weld portion 303, the laser beam 4 is applied while inclined by el degrees from the direction perpendicular to the surface of the object of welding.

The welding joints of the fourth weld portion 304 and the fifth weld portion 305 are of the lap welding structure, and the fourth weld portion 304 and the fifth weld portion 305 are welded by the welding process of embodiment 2. At the fourth weld portion 304 and the fifth weld portion 305, the laser beam 4 is applied perpendicularly to the surface of the object of welding.

Fuel leakage is impermissible in the pump 100. The pump main body 101, the body 114c of the suction valve mechanism 114, the delivery joint 116, the damper cover 111, and the suction joint 112 are components constituting a fuel path through which the fuel flows. The second through fifth weld portions 302 through 305 also serve as fuel seals. Thus, in the welding of the components forming the fuel path, it is desirable to sufficiently secure the effective welding length. Further, it is to be expected that the pump 100 will be used in a harsh environment. By employing a welding process superior in robustness, it is possible to enhance the reliability of the pump 100.

### Embodiment 7

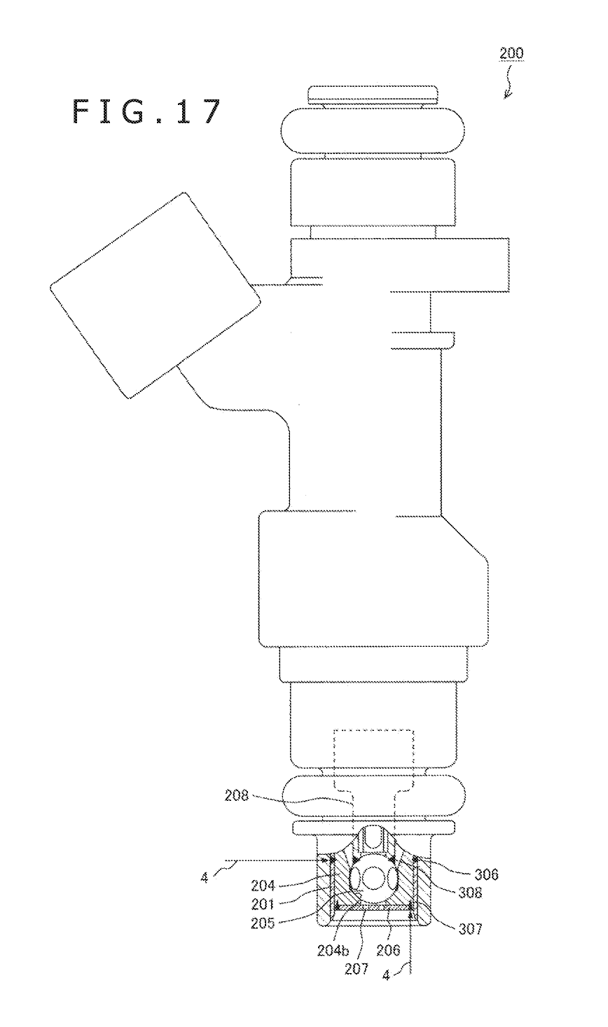

An example in which the present invention is applied to a fuel injection valve 200 will be described with reference to FIG. 17. FIG. 17 is a sectional view of a fuel injection valve according to an embodiment of the present invention.

The fuel injection valve 200 is provided with a tubular body 201 of metal extending from an upper end portion to a lower end portion. At the distal end portion of the tubular body 201, there is provided a valve seat member 204. The valve seat member 204 has a conical surface, and a valve seat 204b is formed on this conical surface.

The valve seat member 204 is inserted into the interior of the distal end side of the tubular body 201, and is fixed to the tubular body 201 by laser welding. This weld portion 306 will be referred to as the sixth weld portion. The welding of the sixth weld portion 306 is executed over the entire periphery from the outer peripheral side of the tubular body 201.

A nozzle plate 206 is mounted to the lower end surface (distal end surface) of the valve seat member 204. The nozzle plate 206 is provided with a plurality of fuel injection holes 207. The nozzle plate 206 is fixed to the valve seat member 204 by laser welding. This weld portion 307 will be referred to as the seventh weld portion. The seventh weld portion 307 is situated around the injection hole formation region so as to surround the injection hole formation region where the fuel injection holes 207 are formed.

A movable part 208 is accommodated in the tubular body 201. A valve body 205 is fixed to the distal end of the movable part 208. The valve body 205 consists of a spherical ball valve. The valve body 205 is fixed to the movable part 208 through laser welding. This weld portion 308 will be referred to as the eighth weld portion. At the eighth weld portion 308, welding is effected over the entire outer periphery of the distal end portion of the movable part 208.

The valve body 205 and the valve seat 204b cooperated with each other to open and close the fuel path. The valve body 205 abuts the valve seat 204b, whereby the fuel path is closed. Further, the valve body 205 moves away from the valve seat 204b, whereby the fuel path is opened. The fuel having passed through the fuel path between the valve body 205 and the valve seat 204b is injected through the fuel injection holes 207.

The welding joints of the sixth weld portion 306 and the seventh weld portion 307 are of the lap welding structure, and the sixth weld portion 306 and the seventh weld portion 307 are welded by the welding process of embodiment 2. At the sixth weld portion 306 and the seventh weld portion 307 are, the laser beam 4 is applied perpendicularly to the surface of the object of welding. At the seventh weld portion 307, the laser beam 4 may be applied while inclined from the direction perpendicular to the surface of the object of welding.

The welding joint of the eighth weld portion 308 is of the butt welding structure or of the fillet welding structure, and the eighth weld portion 308 is welded by the welding process of embodiment 1 or embodiment 3. At the eighth weld portion 308, the laser beam 4 is applied perpendicularly to the surface of the object of welding. Alternatively, the laser beam 4 is applied to the object of welding while inclined from the direction perpendicular to the surface of the object of welding.

Fuel leakage is impermissible in the fuel injection valve 200. The tubular body 201, the valve seat member 204, and the nozzle plate 206 are components constituting a fuel path through which the fuel flows. The sixth weld portion 306 and the seventh weld portion 307 also serve as fuel seals. Thus, it is desirable to sufficiently secure the effective welding length. Further, it is to be expected that the fuel injection valve 200 will be used in a harsh environment. By employing a welding process superior in robustness, it is possible to enhance the reliability of the fuel injection valve 200.

Further, the valve body 205 and the valve seat 204b repeatedly collide with each other over a long period of time. Thus, the welding between the valve body 205 and the movable part 208 at the eighth weld portion 308 needs to be reliable enough to make it possible to maintain a stable state for the weld portion for a long period of time. By applying the welding process according to the present invention, the reliability of the weld portion is secured.

The present invention is not restricted to the above-described embodiments but includes various modifications. For example, the above embodiments have been described in detail in order to facilitate the understanding of the present invention. The present invention is not always restricted to a construction equipped with all the components. Further, it is possible to replace a part of the construction of a certain embodiment by the construction of some other embodiment. Further, it is also possible to add the construction of some other embodiment to the construction of a certain embodiment. Further, with respect to a part of the construction of each embodiment, it is possible to effect addition, deletion, or replacement of some other construction.

In each of the above-described embodiments, both the circular track and the elliptical track may be employed as the scanning track of the laser beam 4.

### DESCRIPTION OF REFERENCE CHARACTERS

1: Laser oscillator

2: Laser optical fiber

3: Galvanoscanner

4: Laser beam

5: Laser beam rotational direction,

6, 6B: Rotational direction of the object of welding

7: Shielding gas nozzle

8: Shielding gas

9, 9a, 9b, 9Aa, 9Ab, 9Ba, 9Bb, 9Ca, 9Cb: Object of welding

10, 10B: Rotary spindle

11: Processing stage

12, 12C: Weld line

13, 13A, 13B, 13C: Low input heat side laser beam application position

14, 14A, 14B, 14C: High input heat side laser beam application position

15, 15A, 15B, 15C: Laser scanning track

16, 16A, 16B, 16C: Laser scanning direction

17, 17A, 17B, 17C: Molten pool

18, 18A, 18B, 18C: Weld portion sectional configuration

19, 19A, 19B, 19C: Effective welding length

20, 20A, 20B, 20C, 20Ca: Bonding surface

21: Laser beam application position

22: Fixation jig

23: Processing stage moving direction

30: Locus

100: High pressure fuel supply pump

101: Pump main body

102: Mounting flange

111: Damper cover

112: Suction joint

114: Suction valve mechanism

114c: Body of the suction valve mechanism 114

116: Delivery joint

200: Fuel injection valve

201: Tubular body

204: Valve seat member

206: Nozzle plate

301: First weld portion

302: Second weld portion

303: Third weld portion

304: Fourth weld portion

305: Fifth weld portion

306: Sixth weld portion

307: Seventh weld portion

308: Eighth weld portion.

1. A laser welding method in which oscillation scanning is periodically effected with a laser beam while moving an object of welding to apply the laser beam to a surface of the object of welding to perform welding,
wherein at least one of an output of the laser beam, a scanning speed, and a scanning track is controlled, whereby welding is effected with input heat amounts on both left and right sides with respect to a welding progressing direction being substantially different from each other.

2. The laser welding method according to claim 1,
wherein a deepest penetration position is deviated to left or right with respect to the welding progressing direction from a center of a weld bead surface.

3. The laser welding method according to claim 1,
wherein scanning is performed in a circular track with the laser beam; in the circular track, on a side where a moving direction of the laser beam and a moving direction of the object of welding are the same, the input heat amount is large; and on a side where the moving direction of the laser beam and the moving direction of the object of welding are opposite, the input heat amount by the laser beam is small.

4. The laser welding method according to claim 3,
wherein the ratio of the input heat amount between the high input heat side and the low input heat side on the left and right sides of the welding progressing direction is larger than −0.107 ln (circle diameter)+1.11.

5. The laser welding method according to claim 1,
wherein scanning is performed with the laser beam in an elliptical track having a major axis in the welding progressing direction and a minor axis in a direction perpendicular to the welding progressing direction.

6. The laser welding method according to claim 5,
wherein a ratio of the input heat amount between a high input heat side and a low input heat side on the left and right sides of the welding progressing direction is larger than −0.107 ln (ellipse minor axis)+1.11.

7. The laser welding method according to claim 1,
wherein scanning is performed with the laser beam in an elliptical track having a minor axis in the welding progressing direction and a major axis in a direction perpendicular to the welding progressing direction.

8. The laser welding method according to claim 7,
wherein a ratio of the input heat amount between a high input heat side and a low input heat side on the left and right sides of the welding progressing direction is larger than −0.107 ln (ellipse major axis)+1.11.

9. The laser welding method according to claim 3,
wherein a welded joint is of a butt welding structure or of a fitting butt welding structure;
a center of the circular track is on a surface of one object of welding with respect to a bonding surface of two objects of welding to be welded to each other; and
a high input heat side is on a surface of one object of welding with respect to the bonding surface of the two objects of welding to be welded to each other.

10. The laser welding method according to claim 1,
wherein a welded joint is of a fillet weld structure in which welding is performed, with other object of welding abutting substantially perpendicularly a plane of one object of welding; and
the laser beam is applied so as to draw a circular track or an elliptical track on a surface of the other object of welding, with the laser beam being applied such that a high input heat side is situated on the one object of welding side with respect to a low input heat side.

11. A high pressure fuel supply pump comprising: a pump main body; a pressurization chamber formed on an inner side of the pump main body; a plunger making a reciprocating motion within the pressurization chamber; a suction valve mechanism provided in the pump main body and supplying a fuel to the pressurization chamber; and a delivery valve mechanism provided in the pump main body and delivering the fuel pressurized in the pressurization chamber,
wherein welding is performed on a weld portion between the pump main body and a component mounted to the pump main body and constituting a fuel path while controlling at least one of a laser output, a scanning speed, and a scanning track such that input heat amounts on left and right sides of the welding progressing direction are substantially different from each other, whereby deepest penetration position is deviated to the right or left with respect to the welding progressing direction from a center of a weld bead surface.

12. A fuel injection valve comprising: a valve seat and a valve body opening and closing a fuel path, and a movable part having the valve body,
wherein welding is performed on a fixation portion between the valve body and the movable part while controlling at least one of a laser output, a scanning speed, and a scanning track such that input heat amounts on left and right sides of a welding progressing direction are substantially different from each other, whereby a deepest penetration position is deviated to the right or left with respect to the welding progressing direction from a center of a weld bead surface.
